(19) United States
(12) Patent Application Publication
(10) Pub. No.: US 2010/0155180 A1
(43) Pub. Date: Jun. 24, 2010

(54) Quick Lubricant Nipple Mechanism with a Check Device

(76) Inventors: Chi-Pin CHOU, Taichung Industrial Park (TW); Ming-Hung Hsieh, Taichung Industrial Park (TW)

Correspondence Address: Dr. BANGER SHIA;Patent Office of Bang Shia, 102 Lindencrest Ct., Sugar Land, TX, 77479-5201, US

(21) Appl. No.: 12/340,735

(22) Filed: Dec. 21, 2008

(51) Int. Cl. F16N 21/02

(52) U.S. Cl. 184/105.3

(57) ABSTRACT

A quick lubricant nipple mechanism with a check device comprises a lubricant nipple which is connected to an extension pipe device having a pipe, an outlet connection, a check valve and an inlet connection. The pipe has one end connected to the outlet connection and the other end connected to one end of the check valve which has the other end connected to the inlet connection. The outlet connection of the extension pipe device is connected to the lubricant nipple, so that the lubricant injection can be carried out quickly and easily and the lubricant gun is easy to align. Hence, with such a device, the lubricant injection can be done by only one person.

### BACKGROUND OF THE INVENTION

1. Field of the Invention

The present invention relates to a quick lubricant nipple mechanism with a check device for injecting lubricant into moving or rolling parts of a mechanism, and more particularly to an improved lubricant injection structure which can inject lubricant quickly and easily.

2. Description of the Prior Art

Lubricant is usually used to prevent friction among various moving or rolling parts of a mechanism. To prevent loss of the lubricant and keep it from dust, the lubricant is usually contained in a sealing structure. However, the lubricant will still be used up gradually along with the rotation of the mechanism, so it must be supplied regularly to maintain the lubricating effect, and the current lubricant supplying method is to use a lubricant nipple to cooperate with a lubricant gun. However, the conventional lubricant nipple is usually located inside the mechanism, which makes the lubricant injection work difficult.

Referring to FIG. 4, a guide rail 70 is provided on a machine table 60, and a slide block 80 which is provided with a lubricant nipple 90 at an end thereof is movably disposed on the guide rail 70. A movable seat 61 of the machine table 60 is mounted on the slide block 80. Lubricant is received in the slide block 80 to smooth the slide motion of the slide block 80 with respect to the guide rail 70, when it is used up, new lubricant will be injected into slide block 80 via the lubricant nipple 90 by a lubricant gun A.

The abovementioned lubricant injection method requires the lubricant gun A to be forced into the lubricant nipple 90. The fact, however, is that the lubricant nipple 90 is usually located either in a corner or in a gap. For example, as shown in FIG. 4, the movable seat 61 above the lubricant nipple 90 of the slide block 80 stands there like an obstacle and makes it difficult for the user to apply force and to align the lubricant gun A with the lubricant nipple 90. In addition, since the slide block 80 is movable especially when injecting lubricant, the lubricant injection operation requires the cooperation of two persons, that is, one person holds the slide block 80 to prevent it from moving, and the other person grasps the lubricant gun A to inject lubricant, naturally, it is very inconvenient. Moreover, although the specially designed lubricant nipple is easy to inject lubricant, its cost is high, and the conventional lubricant nipple usually has the problem of backflow.

The present invention has arisen to mitigate and/or obviate the afore-described disadvantages.

### SUMMARY OF THE INVENTION

The technical problems to be solved:

The abovementioned lubricant injection mechanism requires the lubricant gun to be forced into the lubricant nipple which is usually located inside the machine table, which makes the lubricant injection work difficult and makes it difficult for the user to apply force and to align the lubricant gun with the lubricant nipple. In addition, the lubricant nipple is usually provided in a movable mechanism, so that when injecting lubricant, the lubricant injection operation requires the cooperation of two persons, naturally, it is very inconvenient.

In order to solve the above technical problems, the present invention provides a quick lubricant nipple mechanism with a check device. A lubricant nipple is provided on a machine table and cooperates with an extension pipe device having a pipe, an outlet connection, a check valve and an inlet connection. The pipe has one end connected to the outlet connection and the other end connected to one end of the check valve which has the other end connected to the inlet connection. The outlet connection of the extension pipe device is connected to the lubricant nipple, so as to inject the lubricant.

As compared to the conventional technology, the present invention has the following advantages:

Firstly, no matter the lubricant nipple of the present invention is located in any corner or gap of the machine table, the extension pipe device can extend the lubricant injection position to an open position outside the machine table where lubricant injection can be carried out quickly and easily without any spatial or visual obstacles.

Secondly, since the lubricant nipple of the present invention is connected to the extension pipe device, which makes it easier to align the lubricant gun, and the direction of the inlet connection can also be changed freely with user's action, so as to solve the problem of the conventional lubricant gun that the slide block is likely to falling off when it is pushed by the lubricant gun during lubricant injection. Hence, with the device of the present invention, the lubricant injection can be done by only one person.

Thirdly, the lubricant nipple and the extension pipe device which comprises the pipe, the outlet connection, the check valve and the inlet connection are all standardized structures and specifications without needing to be specially designed and molded, so that the cost is reduced.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a perspective view of a quick lubricant nipple mechanism with a check device in accordance with the present invention;

FIG. 2 is a perspective view showing a lubricant injection state in accordance with a first embodiment of the present invention;

FIG. 3 is a perspective view showing the lubricant injection state in accordance with a second embodiment of the present invention; and

FIG. 4 is an illustrative view showing the lubricant injection state of a conventional lubricant nipple device.

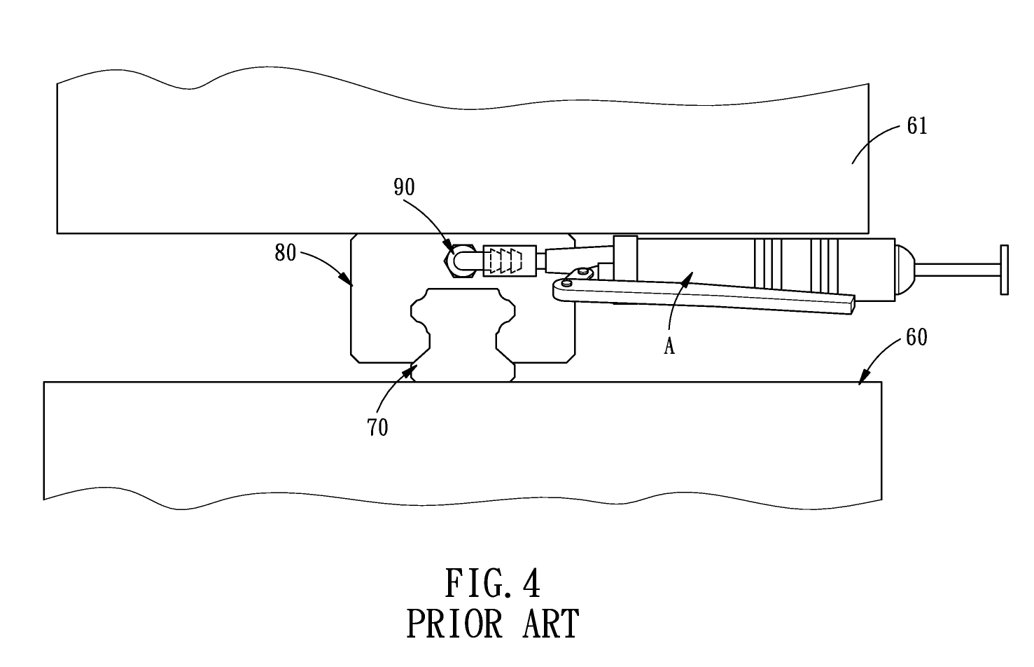

### DETAILED DESCRIPTION OF THE PREFERRED EMBODIMENTS

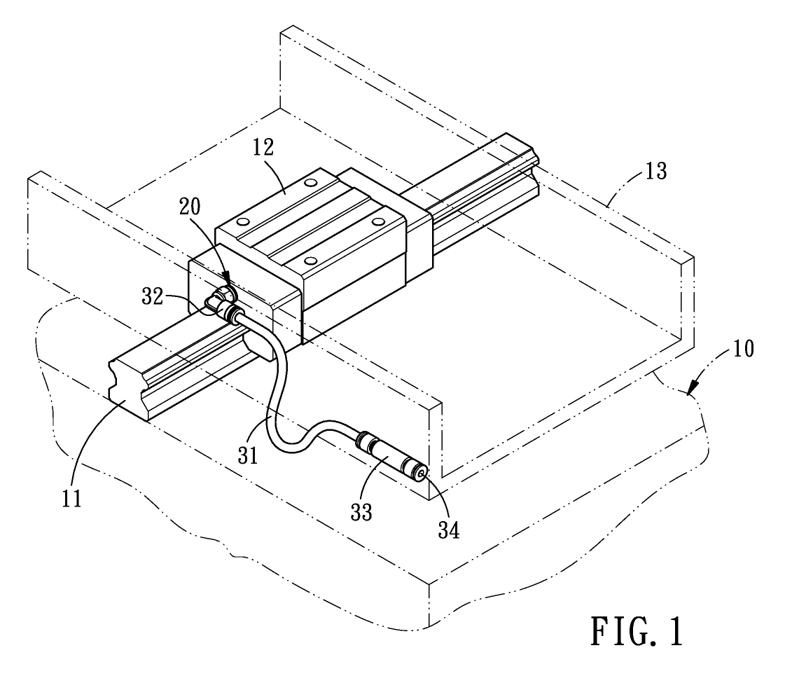

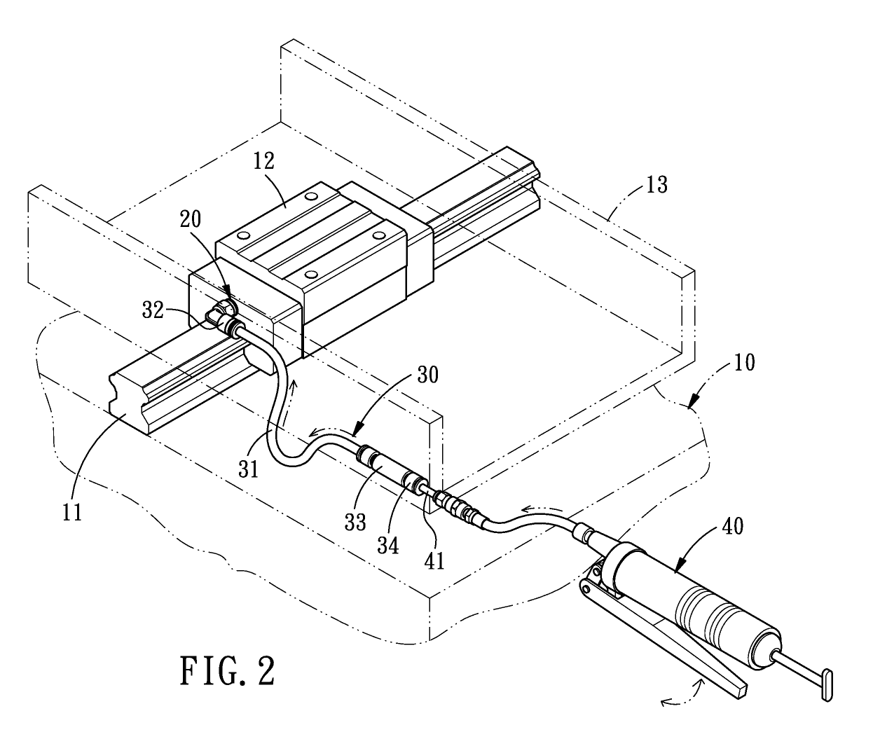

Referring to FIGS. 1 and 2, a quick lubricant nipple mechanism with a check device in accordance with the present invention comprises a machine table 10, a lubricant nipple 20, an extension pipe device 30 and a lubricant gun 40.

On the machine table 10 is provided a guide rail 11 on which is movably disposed a slide block 12 for carrying a movable seat 13 to move on the guide rail 11.

The lubricant nipple 20 is provided on the slide block 12 of the machine table 10.

The extension pipe device 30 comprises a pipe 31, an outlet connection 32, a check valve 33 and an inlet connection 34. The pipe 31 can be flexible or rigid and has one end connected to the outlet connection 32 and the other end connected to one end of the check valve 33 which has the other end connected to the inlet connection 34. The outlet connection 32 of the extension pipe device 30 is connected to the lubricant nipple 20, and through the pipe 31 of the extension pipe device 30, the check valve 33 and the inlet connection 34 are extended to an open position outside the machine table 10, so as to enable the extension pipe device 30 to move along with the lubricant nipple 20 and the slide block 12.

The lubricant gun 40 is provided with a lubricant injection pipe 41 which is connected to the inlet connection 34 of the extension pipe device 30 for injecting the lubricant into the slide block 12 via the extension pipe device 30 and the lubricant nipple 20. During lubricant injection, the extension pipe device 30 utilizes the check valve 33 to solve the problem of backflow.

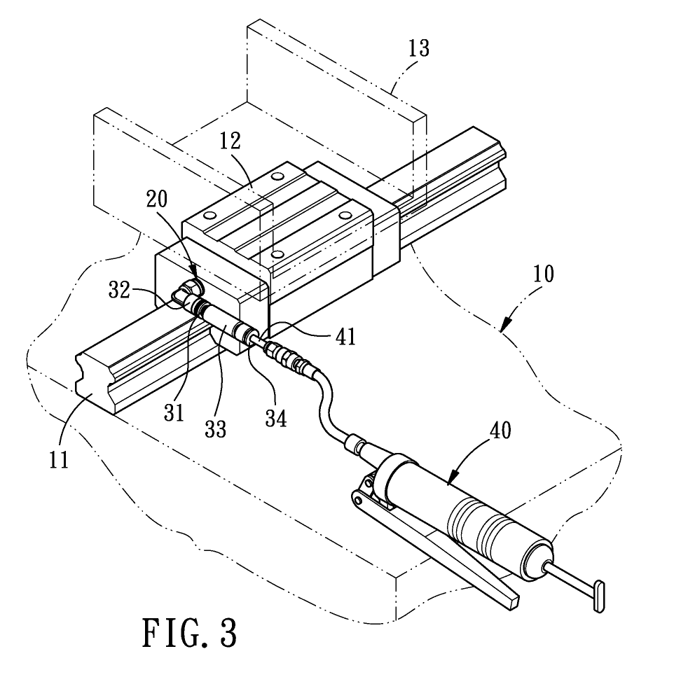

The position and the depth of the lubricant nipple 20 can be different according to different designs of the machine table 10. For example, the inlet connection 34 of the extension pipe device 30 as shown in FIGS. 1 and 2 is extended to the open position outside the machine table 10 by the pipe 31 which is flexible. The inlet connection 34 of the extension pipe device 30 as shown in FIG. 3 is extended to the open position outside the machine table 10 by the pipe 31 which is rigid. The extension pipe device 30 can move along with the lubricant nipple 20 and the slide block 12 whether the pipe 31 is flexible or rigid.

It is apparent from the above-mentioned descriptions that the present invention has the advantages described as follows:

Firstly, no matter the lubricant nipple 20 of the present invention is located in any corner or gap of the machine table 10, the extension pipe device 30 can extend the lubricant injection position to an open position outside the machine table 10 where lubricant injection can be carried out quickly and easily without any spatial or visual obstacles.

Secondly, since the lubricant nipple 20 of the present invention is connected to the extension pipe device 30, which makes it easier to align the lubricant gun 40, and the direction of the inlet connection 34 can also be changed freely with user's action, so as to solve the problem of the conventional lubricant gun that the slide block is likely to falling off when it is pushed by the lubricant gun during lubricant injection. Hence, with the device of the present invention, the lubricant injection can be done by only one person.

Thirdly, the lubricant nipple 20 and the extension pipe device 30 which comprises the pipe 31, the outlet connection 32, the check valve 33 and the inlet connection 34 are all standardized structures and specifications without needing to be specially designed and molded, so that the cost is reduced.

While we have shown and described various embodiments in accordance with the present invention, it should be clear to those skilled in the art that further embodiments may be made without departing from the scope of the present invention.

What is claimed is:

1. A quick lubricant nipple mechanism with a check device comprising:
a machine table;
a lubricant nipple provided on the machine table; and
an extension pipe device comprising a pipe, an outlet connection, a check valve and an inlet connection, the pipe having one end connected to the outlet connection and the other end connected to one end of the check valve which has the other end connected to the inlet connection, the outlet connection of the extension pipe device being connected to the lubricant nipple.

2. The quick lubricant nipple mechanism with a check device as claimed in claim 1, wherein a guide rail is provided on the machine table, on the guide rail is movably disposed a slide block for carrying a movable seat to move on the guide rail, the lubricant nipple is provided on the slide block, and the extension pipe device moves along with the lubricant nipple and the slide block.

3. The quick lubricant nipple mechanism with a check device as claimed in claim 1, wherein the pipe of the extension pipe device is selected from the group consisting of a flexible pipe and a rigid pipe.

4. The quick lubricant nipple mechanism with a check device as claimed in claim 1, wherein the check valve and the inlet connection are extended to a position outside the machine table through the pipe of the extension pipe device.

5. The quick lubricant nipple mechanism with a check device as claimed in claim 1, wherein the extension pipe device cooperates with a lubricant gun, and the lubricant gun is provided with a lubricant injection pipe which is connected to the inlet connection of the extension pipe device for injecting lubricant into the machine table via the extension pipe device.
